(19) United States
(12) Patent Application Publication
(10) Pub. No.: US 2005/0261788 A1
(43) Pub. Date: Nov. 24, 2005

(54) System and method for programmatically searching backwards in a string

(76) Inventor: Michael K. Singman-Aste, Alameda, CA (US)

Correspondence Address: FISH & RICHARDSON P.C., 1717 MAIN STREET, SUITE 5000, DALLAS, TX, 75201, US

(21) Appl. No.: 10/991,307

(22) Filed: Nov. 17, 2004

Related U.S. Application Data
(60) Provisional application No. 60/573,156, filed on May 21, 2004.

(51) Int. Cl. G06F 17/27

(52) U.S. Cl. 700/90

(57) ABSTRACT

This disclosure provides a system and method for programmatically searching backwards in a string. In one embodiment, a development environment is operable to identify an application program interface (API) comprising a class method operable to search backwards for a pattern in a string in response to a request from a developer. The development environment is further operable to insert the class method into software code based on the request and compile the software code into an application. The application includes a backwards searching capability based on the inserted class method.

### RELATED APPLICATION

This application claims the priority under 35 U.S.C. § 119 of provisional application Ser. No. 60/573,156 filed May 21, 2004.

### TECHNICAL FIELD

This disclosure relates generally to the field of development environments and, more particularly, to a system and method for programmatically searching backwards in a string.

### BACKGROUND

Complex software projects typically require the development of multiple modules, components, and/or objects. Development environments provide a suite of tools to facilitate the development of such software. These tools may include reusable classes, functions, routines, or subroutines that perform frequently-needed methods. For example, a development environment may provide a programmer a set of built-in system classes with attributes and methods.

### SUMMARY

This disclosure provides a system and method for programmatically searching backwards in a string. In one embodiment, a development environment is operable to identify an application program interface (API) comprising a class method operable to search backwards for a pattern in a string in response to a request from a developer. The development environment is further operable to insert the class method into software code based on the request and compile the software code into an application. The application includes a backwards searching capability based on the inserted class method. The details of one or more embodiments of the disclosure are set forth in the accompanying drawings and the description below. Other features, objects, and advantages of the disclosure will be apparent from the description and drawings and from the claims.

### DESCRIPTION OF DRAWINGS

FIG. 1 is a block diagram illustrating an exemplary system for providing backwards searching options in a development environment using an application program interface (API);

FIGS. 2A-B are exemplary flow diagrams illustrating an example method for executing the backwards searching capability described in FIG. 1; and

FIG. 3 illustrates one embodiment of a display indicating results of a backwards searching capability described in FIG. 1.

### DETAILED DESCRIPTION

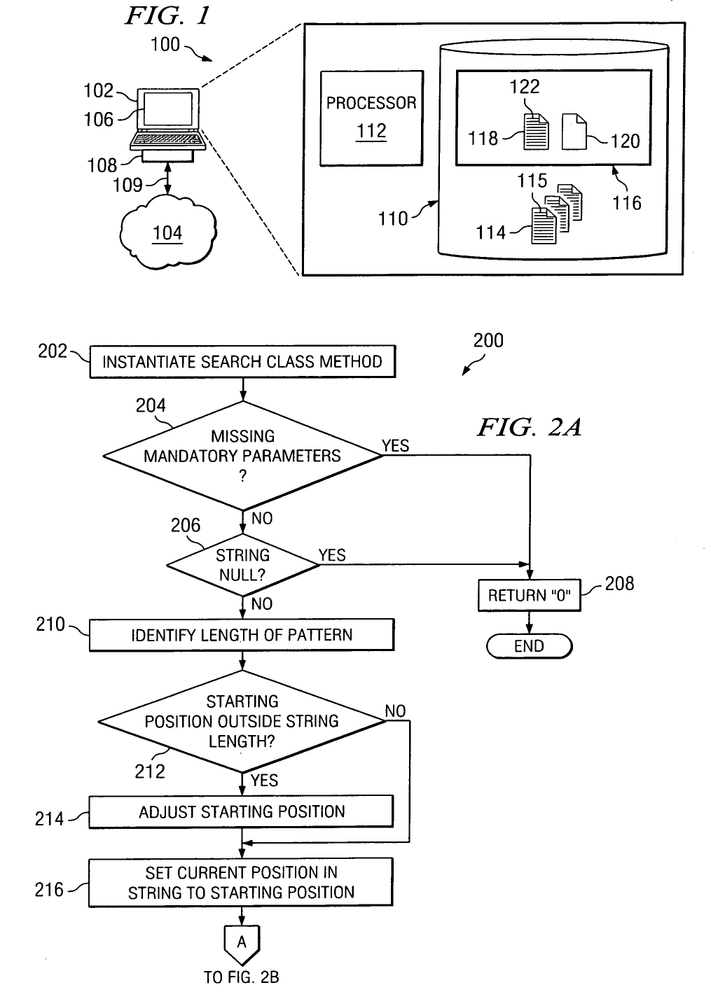

FIG. 1 illustrates one embodiment of a computer system 100 for providing backwards searching in an application 120, which may be developed by a development environment 116 using an application program interface 118. For example, a developer may select a class method of API 118 operable to search backwards for a pattern in a string and insert the class method into software code for an application without having to write the source code for the class method. After compiling the software code, the application is operable to present a backwards search option to a user. At a high level, system 100 may be a single computer 102 or any portion of a distributed or enterprise system including at least computer 102, perhaps communicably coupled to a network 104. For example, computer 102 may comprise a portion of an information management system or enterprise network that provides a number of software applications to any number of clients. Alternatively, computer 102 may comprise a client processing information in a distributed information management system or enterprise network via one or more software applications. In either case, system 100 is any system that provides an API 118 including a class method operable to search backwards for a pattern in a string. In certain embodiments, some of the disclosed techniques may allow developers to quickly and easily include backwards search capability in their programs without the need to write their own solutions.

Computer 102 includes a Graphical User Interface (GUI) 106, network interface 108, memory 110, and processor 112. In certain embodiments, computer 102 further includes or references a development environment 116 and documents 114 that may be stored in memory 110 and may be processed by processor 112. FIG. 1 illustrates only one example of a computer that may be used with the disclosure. The present disclosure contemplates computers other than general purpose computers as well as computers without conventional operating systems. As used in this document, the term “computer” is intended to encompass a mainframe, a personal computer, a client, a server, a workstation, a network computer, a personal digital assistant, a mobile phone, or any other suitable local or remote processing device. Moreover, “computer 102” and “user of computer 102” may be used interchangeably without departing from the scope of this disclosure.

GUI 106 comprises a graphical user interface operable to allow the user of computer 102 to interact with processor 112. Generally, GUI 106 provides the user of computer 102 with an efficient and user-friendly presentation of data provided by computer 102. GUI 106 may comprise a plurality of displays having interactive fields, pull-down lists, and buttons operated by the user. And in one example, GUI 106 presents an explore-type interface and receives commands from the user. It should be understood that the term graphical user interface may be used in the singular or in the plural to describe one or more graphical user interfaces in each of the displays of a particular graphical user interface. Further, GUI 106 contemplates any graphical user interface, such as a generic web browser, that processes information in computer 102 and efficiently presents the information to the user. Network 104 can accept data from the user of computer 102 via the web browser (e.g., Microsoft Internet Explorer or Netscape Navigator) and return the appropriate HyperText Markup Language (HTML) or extensible Markup Language (XML) responses. Computer 102 may include network interface 108 for communicating with other computer systems over network 104 such as, for example, in a client-server or other distributed environment via link 109. In certain embodiments, computer 102 may generate requests and/or responses and communicate them to a client, server, or other computer systems located in network 104. Network 104 facilitates wireless or wireline communication between computer system 100 and any other computer. Network 104 may communicate, for example, Internet Protocol (IP) packets, Frame Relay frames, Asynchronous Transfer Mode (ATM) cells, voice, video, data, and other suitable information between network addresses. Network 104 may include one or more local area networks (LANs), radio access networks (RANs), metropolitan area networks (MANs), wide area networks (WANs), all or a portion of the Internet, and/or any other communication system or systems at one or more locations. Generally, interface 108 comprises logic encoded in software and/or hardware in any suitable combination to allow computer 102 to communicate with network 104 via link 109. More specifically, interface 108 may comprise software supporting one or more communications protocols associated with link 109 and communications hardware operable to communicate physical signals.

Memory 110 may include any memory or database module and may take the form of volatile or non-volatile memory including, for example, magnetic media, optical media, Random Access Memory (RAM), Read Only Memory (ROM), removable media, or any other suitable local or remote memory component. In the illustrated embodiment, memory 110 includes or references one or more documents 114 and development environment 116. Document 114 comprises a file, table, variable, or any other data structure accessible by application 120. Document 114 may be any suitable format such as, for example, an XML document, a flat file, comma-separated-value (CSV) file, a name-value pair file, SQL table, an array, an object, or others. Document 114 may be dynamically created or populated by computer 102, a third-party vendor, any suitable user of computer 102, loaded from a default file, or received via network 104. The term “dynamically” as used herein, generally means that the appropriate processing is determined at run-time based upon the appropriate information. For example, in one embodiment, document 114 includes a string 115 that may be a sequence of symbols, letters, numbers, characters, or any other appropriate data without departing from the scope of this disclosure. Character positions of string 115 may be numbered or logically processed from left to right thereby providing ordinal positions for the characters of string 115.

Development environment 116 comprises a suite of tools to aid in the development of application 120. For example, development environment 116 may comprise API 118, a compiler, an editor, a debugger, a profiler, a source code manager, or other suitable tools. Development environment 116 may be based on any appropriate computer language such as, for example, C, C++, Java, Perl, Visual Basic, 4GL, and others. In one embodiment, development environment 116 comprises an integrated development environment (IDE) employing an object-oriented 4GL. It will be understood that while development environment 116 is illustrated as a single multi-tasked module, the features and functionality performed by this engine may be performed by multiple modules, libraries or other components. Further, development environment 116 may comprise a child or sub-module of another application (not illustrated) without departing from the scope of the disclosure. In summary, development environment 116 provides API 118 to a developer of application 120.

API 118 comprises any conventional application program interface, including standard or proprietary and includes a class method 122 for searching in a string. In general, API 118 includes a set of routines, protocols, and/or tools used to generate programs. API 118 may comprise a file, script, executable, template or any other suitable description such that computer 102 may generate application 120 with at least backwards searching capabilities. API 118 may be created or supplied by computer 102, a third party, or any other suitable user of system 100. In one embodiment, API 118 includes either source code for class definitions written in or an executable code for class definitions based on any appropriate language such as, for example, C, C++, Java, Perl, and others. The class definitions are used to specify features and functions for application 120. For example, API 118 may comprise class method 122 operable to search backwards for a pattern in string 115. In one embodiment, class method 122 returns the ordinal position of the pattern in string 115. Class method 122 may comprise a dynamically linked library (DLL), a method executed by an object, and others.

Based on API 118 class definitions, development environment 116 generates application 120. Application 120 is any suitable application software running on computer 102 operable to search backwards for a pattern in a string. For example, application 120 may comprise a database program, word processing program, or any other software application that is operable to search or otherwise process one or more documents 114. Application 120 may be based on any appropriate computer language such as, for example, C, C++, Java, Perl, Visual Basic, 4GL, and others. For example, application 120 may include or implement a generic 4GL script similar to that illustrated below that includes a call to class method 122 for searching backwards for a pattern in a string and identifying the end of the previous sentence before the first occurrence of the word “contract.” It will be understood that the word “contract” is for example purposes only and class method 122 may search for any suitable static or dynamic pattern supplied by a person, process, computer, and others.

initialize( )=
{
}
Attorney Docket No.: 17646-140001/ 20000334
on click btn_find =
declare

ret = integer not null;

enddeclare
{

/*
** Search forwards from the beginning of the document
*/
ret = ef_string.LocateString(match = ‘contract’,

startposition = 1,
ignorecase = TRUE);

if ret = 0 then

CurFrame.InfoPopup(messagetext = ‘contract not found’,

messagetype = MT_WARNING);

else

/*
** Search backwards from the location of “contract”
*/
ret = ef_string.LocateString(match = ‘.’,

startposition = ret,
backwards = TRUE);

if ret = 0 then

CurFrame.InfoPopup(messagetext = ‘No previous sentence found’,

messagetype = MT_WARNING);

else

CurFrame.InfoPopup(messagetext = ‘Previous sentence ends at position’ +

varchar(ret),
messagetype = MT_INFO);

endif;

endif;

}

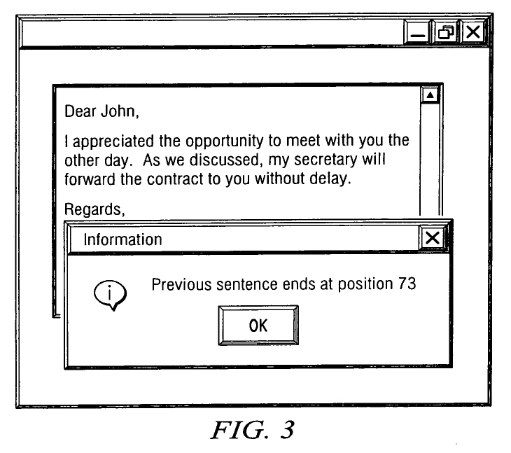

In this example, text is typed into a multiline entry field (“ef_string”) and the search is initiated by pressing button (“btn_find”). In response, a popup window (such as, for example, illustrated in FIG. 3) displays the results of such a search. It will be understood that the results may otherwise be indicated to a user of application 120. This example code includes a call to class method 122, indicated by “LocateString,” of API 118 and is illustrated below:
ret=ef_string.LocateString(match=‘.’
startposition=ret,
backwards=TRUE)
   The “match” parameter identifies the pattern to be searched for in a selected string and, in this case, is a period. The “startposition” parameter identifies the starting position for the search. The “backwards” parameter determines whether the search will be backwards or forwards depending on the values “TRUE” or “FALSE,” respectively. The illustrated method may also include an optional “ignorecase” parameter (not illustrated) that determines whether the search will be case-insensitive or case-sensitive depending on the values “TRUE” or “FALSE,” respectively. The example code is for illustration purposes only and application 120 may comprise any logic (represented by none, some, or all of the illustrated code as well as that not illustrated) operable to backwards search for a pattern in a string. The LocateString method could be implemented by any object, a function in a traditional language, or any other code or executable operable to present a developer with the ability to implement searching in application 120. It will be understood that while application 120 is illustrated as a single multitasked module, the features and functionality performed by this engine may be performed by multiple modules. Moreover, application 120 may comprise a child or submodule of another software module, not illustrated, without departing from the scope of this disclosure.

Returning to illustrated computer 102, processor 112 executes instructions and manipulates data to perform operations of computer 102. For example, processor 112 executes development environment 116, application 120, and other suitable executables or applications. Although FIG. 1 illustrates a single processor 112 in computer 102, multiple processors 112 may be used according to particular needs and reference to processor 112 is meant to include multiple processors 112 where applicable.

In one aspect of operation, a developer using development environment 116 writes, modifies, or otherwise develops software code for application 120 that includes an option to search backwards for a pattern in a selected string. It will be understood that developing code may include writing a program in a text-based programming language, associating elements in a graphical programming language, making selections in a GUI presented by development environment 116, or performing any other suitable operations to generate application 120. During the course of development of the software code, the developer identifies an appropriate place to include a backwards searching option in application 120. For example, the developer may insert class method 122, which is typically predefined, into the software code. Class method 122 may be inserted by including a call in the software code, making a selection in a GUI presented by development environment 116, or performing any other suitable operation. In response to the insertion, computer 102 may import source code into the software code, import object code into application 120 during compilation, or insert class method 122 by any other suitable manner. Alternatively, class method 122 may be stored in a dynamically linked library (DLL) such that during runtime, application 120 makes calls, including passing parameters, to the DLL to perform the task of searching backwards for a pattern in a string. In addition to inserting class method 122, the developer may also insert or identify a header file, associated class methods, parameters, or any other suitable data structure or algorithm to support class method 122. In certain embodiments, the developer selects variables to be included in class method 122 such as, for example, case-sensitivity, pattern length, or others. The values for these variables may be defined in the software code, provided by the user of application 120, provided by a process running on computer 102, or provided by any other suitable manner.

During code development, the developer may additionally decide how to present the backwards searching capability to a user. For example, this capability may be executed by the user via a menu, a hot key, a graphical button, a text command, or any suitable component. In selecting or otherwise developing the presentation of this option, the developer may write his own solution for the presentation, make a selection in a GUI presented by development environment 116, insert calls to a class method, or perform any other suitable operation. This selection may also require selecting the variables of the presentation such as, for example, font, size, color, location, and others. Further, application 120 may dynamically identify some or all of the presentation variables to present the backwards search capability to a user of application 120. The term “dynamically,” as used herein, generally means that certain processing is determined, at least in part, at run-time based on one or more variables. Moreover, class method 122 may be implemented in a more automatic technique. Put another way, an instance of class method 122 may not present a backwards searching option to a user of application 120, but instead may execute the backwards searching capability to support other processes at least partially represented in or executed by application 120. As a result, the execution of class method 122 may not be apparent to a user of application 120.

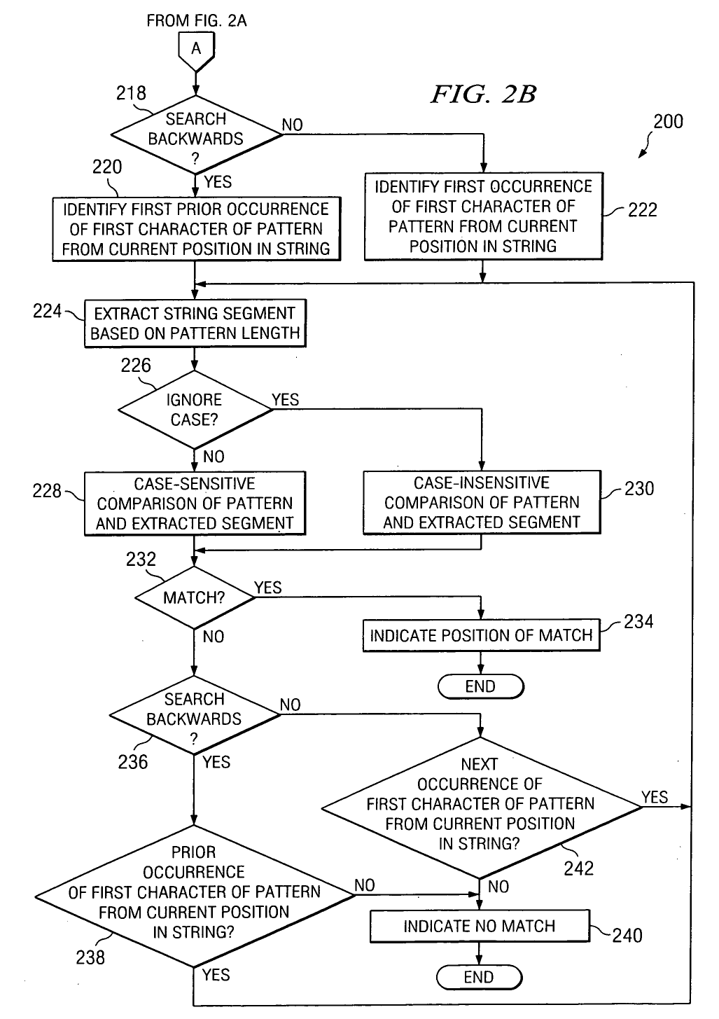

FIGS. 2A and 2B are flow diagrams illustrating example method 200 for using application 120 to execute a searching option. Method 200 is described with respect to application 120 of FIG. 1, but method 200 could be used by any other application or applications. Moreover, application 120 may use any other suitable techniques for performing these tasks. Thus, many of the steps in this flowchart may take place simultaneously and/or in different orders as shown. Further, application 120 may execute logic implementing techniques similar to one or both of method 200 in parallel or in sequence. Application 120 may also use methods with additional steps, fewer steps, and/or different steps, so long as the methods remain appropriate. For example, application 120 may execute a backwards search by locating the first character of the search pattern and determining from that position whether string 115 includes the particular search pattern.

Method 200 begins at step 202 where computer 102 instantiates class method 122. At decisional step 204, if the method has missing mandatory parameters, computer 102 returns a “0” or other empty-string message to application 120 at step 208. If the method has no missing mandatory parameters at decisional step 204, then execution proceeds to decisional step 206. If string 115 is null at decisional step 206, then computer 102 returns a “0” or other empty-string message to application 120 at step 208. If string 115 is not null at decisional step 206, then execution proceeds to step 210. Computer 102 determines a length of the search pattern at step 210. If the starting position of the search is outside the length of string 115 at decisional step 212, then, at step 214, computer 102 adjusts the starting position to fall within the length of string 115. If the starting position of the search is not outside the length of string 115 at decisional step 212, then execution proceeds to step 216. At step 216, computer 102 sets the current position in string 115 to the starting position. Once the string position falls within the length of string 115, execution then proceeds to decisional step 218.

If computer 102 is to perform a backwards search of string 115 at decisional step 218, then, at step 220, computer 102 identifies the first prior occurrence of the first character of the pattern from the current position in string 115. If computer 102 is to perform a forwards search of string 115 at decisional step 218, then, at step 222, computer 102 identifies the first occurrence of the first character of the pattern from the current position in string 115. In either case, execution proceeds to step 224 where a string segment based on the pattern length is extracted from string 115. If computer 102 is performing a case-sensitive comparison of the pattern and the extracted segment at decisional step 226, then, at step 228, computer 102 performs a case-sensitive comparison of the pattern and the extracted segment. If computer 102 is to ignore the case while comparing the pattern and the extracted segment at decisional step 226, then, at step 230, computer 102 performs a case-insensitive comparison of the pattern and the extracted segment. In either case, execution proceeds to decisional step 232. If computer 102 determines that the pattern and the extract segment do match at decisional step 232, then execution proceeds to step 234. Computer 102 indicates the position of the match at step 234. If the compared segments do not match at decisional step 232, execution proceeds to decisional step 236.

If the search is being performed backwards at decisional step 236, then execution proceeds to decisional step 238. If computer 102 does not locate a prior occurrence of the first character of the pattern from the current position of string 115, then, at step 240, computer 102 indicates that no match was found. Execution then ends. If computer 102 identifies a prior occurrence of the first character of the pattern from the current position of string 115, then execution returns to step 224. Returning to decisional step 236, if computer 102 is performing a forwards search, then execution proceeds to decisional step 242. If computer 102 does not locate a next occurrence of the first character of the pattern from the current position in string 115, then at step 240, computer 102 indicates that no match was found. If computer 102 identifies a next occurrence of the first character of the pattern from the current position in string 115 at decisional step 242, then execution returns to step 224.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A development environment operable to:
identify an application program interface (API) comprising a class method operable to search backwards for a pattern in a string in response to a request from a developer;
insert the class method into software code based on the request; and
compile the software code into an application, the application including a backwards searching capability based on the inserted class method.

2. The development environment of claim 1, the class method further operable to search forwards for a pattern in a string in response to a request from a developer.

3. The development environment of claim 2, the application presenting backwards and forwards searching options to a user.

4. The development environment of claim 1, the class method further operable to search a string backwards for a pattern in the string from a specified position in the string.

5. The development environment of claim 4, the class method further operable to adjust the specified position in response to the specified position being outside a length of the string.

6. The development environment of claim 1, wherein the class method implements case-sensitive searching.

7. The development environment of claim 1, the application operable to display results of a backwards search in a window.

8. The development environment of claim 1, the class method comprises an object-oriented fourth generation language (4GL).

9. The development environment of claim 1, the API comprising an executable generated by the developer.

10. A method for providing a development environment, comprising:
identifying an application program interface (API) comprising a class method operable to search backwards for a pattern in a string in response to a request from a developer;
inserting the class method into software code based on the request; and
compiling the software code into an application, the application including a backwards searching capability based on the inserted class method.

11. The method of claim 10, the class method further operable to search forwards for a pattern in a string in response to a request from a developer.

12. The method of claim 11, the application presenting both backwards and forwards searching options to a user.

13. The method of claim 10, the class method further operable to search a string backwards for a pattern in the string from a specified position in the string.

14. The method of claim 13, the class method further operable to adjust the specified position in response to the specified position being outside a length of the string.

15. The method of claim 10, wherein the class method implements case-sensitive searching.

16. The method of claim 10, the application operable to display results of a backwards search in a window.

17. The method of claim 10, the class method comprises an object-oriented fourth generation language (4GL).

18. The method of claim 10, the API comprising an executable generated by the developer.

19. A system for providing a development environment, comprising:
memory operable to store an application program interface (API); and
one or more processors operable to:
identify the API comprising a class method operable to search backwards for a pattern in a string in response to a request from a developer;
insert the class method into software code based on the request; and
compile the software code into an application, the application including a backwards searching capability based on the inserted class method.

20. The system of claim 19, the class method further operable to search forwards for a pattern in a string in response to a request from a developer.

21. The system of claim 20, the application presenting both backwards and forwards searching options to a user.

22. The system of claim 19, the class method further operable to search a string backwards for a pattern in the string from a specified position in the string.

23. The system of claim 19, the class method further operable to adjust the specified position in response to the specified position being outside a length of the string.

24. The system of claim 19, wherein the class method implements case-sensitive searching.

25. The system of claim 19, the application operable to display results of a backwards search in a window.

26. The system of claim 19, the class method comprises an object-oriented fourth generation language (4GL).

27. The system of claim 19, the API comprising an executable generated by the developer.

28. A system for providing a development environment comprising:
means for identifying the API comprising a class method operable to search backwards for a pattern in a string in response to a request from a developer;
means for inserting the class method into software code based on the request; and
means for compiling the software code into an application, the application including a backwards searching capability based on the inserted class method.

29. A development environment operable to:
identify an application program interface (API) comprising a class method operable to search backwards and forwards for a pattern in a string from a specified position in the string in response to a request from a developer, the class method implements case-sensitive searching, the API comprising an executable generated by the developer;
insert the class method into software code based on the request, the software code comprises an object-oriented fourth generation language; and
compile the software code into an application, the application presenting to a user both backwards and forwards searching capability based on the inserted class method.
